(19) United States
(12) Patent Application Publication
(10) Pub. No.: US 2018/0357679 A1
(43) Pub. Date: Dec. 13, 2018

(54) AUCTION ENGINE FOR SUBSCRIBING TO CRITERIA BASED RESULTS

(71) Applicant: Element Data, Inc., Seattle, WA (US)

(72) Inventors: Viswanath Vadlamani, Sammamish, WA (US); Phani Vaddadi, Bellevue, WA (US); Charles F. L. Davis, III, Elk Grove, CA (US)

(21) Appl. No.: 15/826,505

(22) Filed: Nov. 29, 2017

Related U.S. Application Data
(60) Provisional application No. 62/516,783, filed on Jun. 8, 2017.

(51) Int. Cl. G06Q 30/02; G06Q 30/08; H04L 29/08

(52) U.S. Cl. CPC G06Q 30/0275; H04L 67/26; G06Q 30/08

(57) ABSTRACT

Example methods, apparatuses, and systems (e.g., machines) are presented for an auction platform that determines winning bids for high value digital message content using a multi-tiered share-rank system. The auction platform allows for subscribers to bid for merely a share of a set of high value digital message content. Multiple other subscribers may also bid for the same share amount of the set of high value digital message content. The collective bids of multiple subscribers that equals the entire set of the high value digital message content is then compared against other subscribers who have formed collective bids by different sized shares.

### CROSS REFERENCE TO RELATED APPLICATION

This application claims the benefit of U.S. Provisional Application 62/516,783, filed Jun. 8, 2017, and titled “AUCTION ENGINE FOR SUBSCRIBING TO CRITERIA BASED RESULTS,” the disclosure of which is hereby incorporated herein in its entirety and for all purposes.

### TECHNICAL FIELD

The subject matter disclosed herein generally relates to processing data. In some example embodiments, the present disclosures relate to an auction engine for subscribing to criteria-based results, and methods therefrom.

### BACKGROUND

Auctions for digital message content, such as those that resolve what companies get to display advertisements for certain keyword searches in search engines and at what price, can occur nearly instantaneously over digital network channels. The bids may be derived from algorithms by digital subscribers, where a human does not necessarily know when an auction is taking place, nor what exactly is the digital message content being auctioned. In this environment that is too fast for humans to manually control, competitions between subscribers with an uneven amount of resources occur constantly. The market for this environment possesses some economic inefficiencies, however, due to auction systems that lack flexibility to accommodate subscribers of varying sizes. It is desirable to create an auction platform environment that provides more flexibility for subscribers, so that more subscribers can participate.

### BRIEF SUMMARY

Aspects of the present disclosure are presented for an auction platform and associated methods for conducting auctions for high value digital message content using a unique concept of share-ranks that enable bidders to bid on different amounts of the digital message content during the same auction.

In some embodiments, a method of an auction platform for conducting an auction for a set of digital message content, the set of digital message content capable of being subdivided into multiple portions of digital message content, is presented. The method may include: accessing, by the auction platform, an auction criteria expression from a subscriber of the auction engine, the auction criteria expression comprising: a description of auction content to bid on that is associated with the set of digital message content; a bidding amount representing a portion of the set of digital message content that the subscriber intends to bid on, wherein the portion is a subset of the entire set of digital message content; and a bid-price representing a price that the subscriber is willing to pay for the bidding amount portion of the digital message content. The method may further include evaluating, by a natural language processing engine of the auction platform, the auction criteria expression to determine a bid associated with the digital message content, the bid comprising: the description of the digital message content; the portion of the set of digital message content that the subscriber wants to bid on; and the bid-price of that portion. The method may further include placing the bid into the auction for the set of digital message content by placing the bid into a share-rank, the share-rank comprising all bids from a plurality of subscribers for only the portion of the set of digital message content; determining, by the auction platform, that the subscriber's bid is associated with a winning share-rank for the set of the digital message content; and notifying, by the auction platform, the subscriber that the subscriber's bid is a winning bid and is associated with the winning share-rank for the set of the digital message content.

In some embodiments of the method, determining that the subscriber's bid is associated with a winning share-rank for the set of the digital message content comprises determining an accumulated bid-price for the share-rank that the subscriber's bid is placed into; comparing the accumulated bid-price of the subscriber's bid's share-rank to other accumulated bid-prices of other share-ranks; and determining that the accumulated bid-price of the subscriber's bid's share-rank is the highest accumulated bid-price.

In some embodiments, the method further includes: determining a plurality of additional winning subscribers' bids belonging to the winning share-rank; and notifying, by the auction platform, the plurality of additional winning subscribers that their respective winning bids are associated with the winning share-rank for the set of the digital message content.

In some embodiments of the method, evaluating the auction criteria expression to determine a bid associated with the digital message content comprises utilizing natural language processing, machine learning, and Universal Human Relevance System programming to evaluate the auction criteria expression.

In some embodiments of the method, the auction for the set of digital message content comprises a plurality of share-ranks, the plurality of share ranks including: a first share-rank representing all bids that each want to bid on the entire set of the digital message content; a second share-rank representing all bids that each want to bid on half of the set of the digital message content; a third share-rank representing all bids that each want to bid on a third of the set of the digital message content; and a fourth share-rank representing all bids that each want to bid on a fourth of the set of the digital message content.

In some embodiments, the method further comprises determining, by the auction platform, that the subscriber has a quota of funds to spend that has not yet been expended through winning one or more auctions.

In some embodiments, the method further comprises determining, by the auction platform, that the subscriber has reached a quota limit by being associated with the winning share-rank for the digital message content.

In some embodiments, an auction system for conducting an auction for a set of digital message content, the set of digital message content capable of being subdivided into multiple portions of digital message content is presented. the auction system may include: an auction engine; a portal for interfacing with one or more subscribers; and a natural language processing engine. The auction engine may be configured to: access, via the portal, an auction criteria expression from a subscriber, the auction criteria expression comprising: a description of auction content to bid on that is associated with the set of digital message content; a bidding amount representing a portion of the set of digital message content that the subscriber intends to bid on, wherein the portion is a subset of the entire set of digital message content; and a bid-price representing a price that the subscriber is willing to pay for the bidding amount portion of the digital message content. The natural language processor may be configured to evaluate the auction criteria expression to determine a bid associated with the digital message content, the bid comprising: the description of the digital message content; the portion of the set of digital message content that the subscriber wants to bid on; and the bid-price of that portion. The auction engine may be further configured to: place the bid into the auction for the set of digital message content by placing the bid into a share-rank, the share-rank comprising all bids from a plurality of subscribers bidding for only the portion of the set of digital message content; determine that the subscriber's bid is associated with a winning share-rank for the set of the digital message content; and notify the subscriber that the subscriber's bid is a winning bid and is associated with the winning share-rank for the set of the digital message content.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 shows an example functional block diagram of an auction engine or platform of the present disclosure, according to some embodiments.

FIG. 3 shows a functional block diagram for how an auction is resolved, according to some embodiments.

FIG. 4 provides a functional diagram for determining the winner of the auction and for conducting post-auction settlement actions, according to some embodiments.

FIG. 5 provides an example methodology of an auction engine of the present disclosure for harvesting bids to an auction and performing the auction, according to some embodiments.

FIG. 6 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for an auction platform that determines winning bids for high value digital message content using a multi-tiered share-rank system. The auction platform allows for subscribers to bid for merely a share of a set of high value digital message content. Multiple other subscribers may also bid for the same share amount of the set of high value digital message content. The collective bids of multiple subscribers whose fractional shares sum to the entire set of the high value digital message content is then compared against other subscribers who have similarly formed collective bids by different sized shares.

For example, three subscribers may place bids for placing ads each to a third of a set of high value digital message content, such as all search terms related to traveling to Australia. Each of these three subscribers places a bid to pay for (and place ads for) only a third of the whole set. These three subscribers may form a collective bid for this entire set of high value digital message content at the share-rank tier of 3. A fourth subscriber places a bid for the entire set of this high value digital message content. The fourth subscriber therefore constitutes its own bid at the share-rank tier of 1. The collective bid of the three subscribers may then be compared against the fourth subscriber's single bid at auction Similarly, many more subscribers may place bids within a share-rank of their own choosing, with proportional bids corresponding to their fractional share of the high value digital message content. The collective winners of each share-rank then get compared against each other at auction to determine which subscriber(s) win the auction. In this way, the auction platform of the present disclosure may be seen as conducting multiple stages of auction for a single “item” at auction, i.e., determining which subscribers will win the bid at each share-rank, and determining which share-rank will win the overall auction of the entire set of high value digital content (and therefore, which subscriber(s) will win the overall auction).

In general, the subscribers do not have to be made aware of each other, and most often do not know who else is bidding, how much, or within what share-rank. The auction platform accepts all bids according to the specific bidding parameters by each participating subscriber, and performs various calculations to determine which subscriber(s) win(s) the auction, and at what share-rank tier.

In some embodiments, since subscribers do not necessarily bid on the same amount of content and the auction therefore does not explicitly define the parameters to be bid on, the auction engine may interpret the type and amount of content desired to be bid on by a subscriber, based on natural language parameters entered by the subscriber. The auction engine may utilize natural language processing, machine learning, and UHRS modeling to interpret criteria specified by the subscriber. Because the criteria may be expressed in many different ways, the criteria may then cause the subscriber's bid to be fit into a particular share-rank, while a second subscriber's differently worded criteria may cause the second subscriber's bid to fit into the same share-rank. The auction engine may be configured to handle an open-ended amount of bids, unlike traditional auctions that specify a discrete list of items that everybody is constrained to bid on.

The auction platform of the present disclosure includes an environment for subscribers to set up auction criteria for an arbitrary number of different bids for different digital message content, according to some embodiments. Subscribers may place bids up to a quota that is managed by the auction platform, in some cases. The auction platform may also provide various interfaces for interacting with the subscribers to notify them of the statuses of their bids in multiple auctions. Winning bids can have their expenditures deducted automatically from any quota limitations, by the auction engine.

The auction platform of the present disclosure allows for a fair comparison of subscribers having different levels of resources, and different perceived value of the same type of digital message content, to possibly make bids in the same setting. This auction platform may help improve the auction environment by providing more opportunities to a diversity of subscribers who might otherwise struggle to compete with those who have greater resources. The auction platform of the present disclosure may leverage the fact that a single amount of high value digital message content can be viewed in varying levels of sub-divisions, e.g., thirds, fourths, fifths, etc., and therefore it is not required that subscribers must bid for the same discrete amounts, even while bidding for the same type of content.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

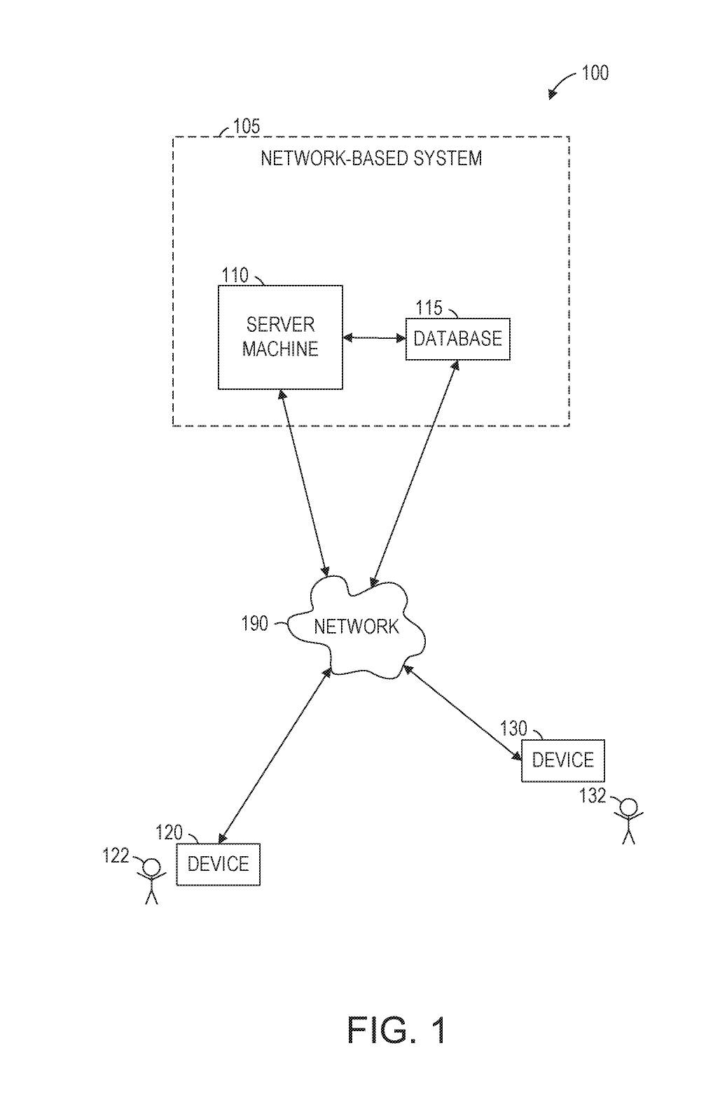

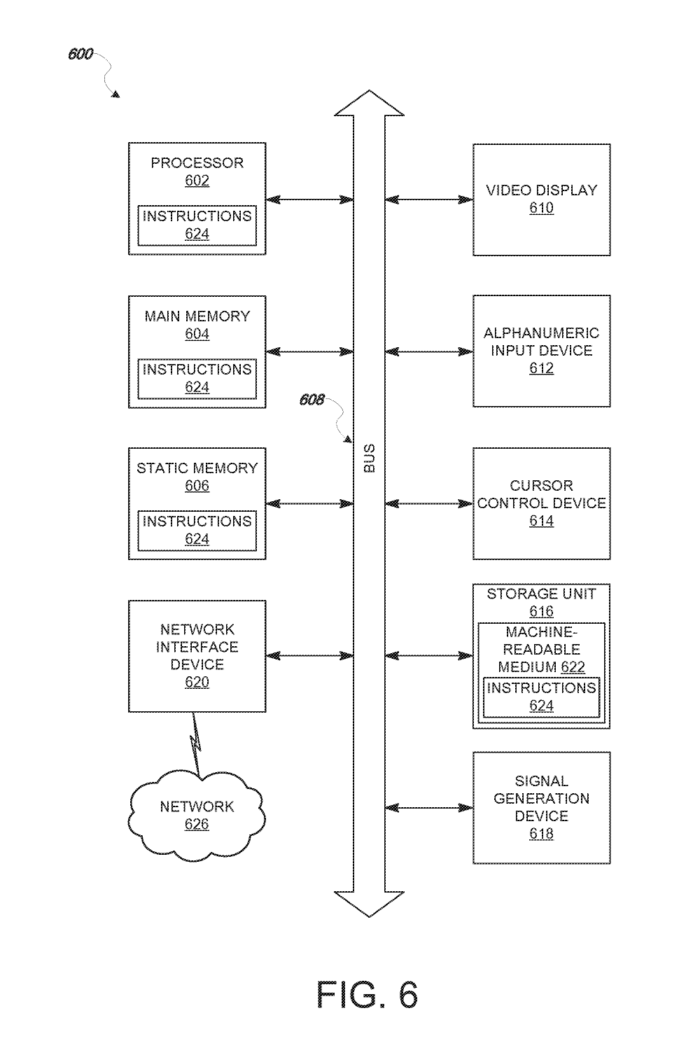

Referring to FIG. 1, a network diagram illustrating an example network environment 100 suitable for performing aspects of the present disclosure is shown, according to some example embodiments. The example network environment 100 includes a server machine 110, a database 115, a first device 120 for a first user 122, and a second device 130 for a second user 132, all communicatively coupled to each other via a network 190. The server machine 110 may form all or part of a network-based system 105 (e.g., a cloud-based server system configured to provide one or more services to the first and second devices 120 and 130). The server machine 110, the first device 120, and the second device 130 may each be implemented in a computer system, in whole or in part, as described below with respect to FIG. 6. The network-based system 105 may be an example of an auction engine or platform according to the descriptions herein. The server machine 110 and the database 115 may be components of the auction engine configured to perform these functions. While the server machine 110 is represented as just a single machine and the database 115 where is represented as just a single database, in some embodiments, multiple server machines and multiple databases communicatively coupled in parallel or in serial may be utilized, and embodiments are not so limited.

Also shown in FIG. 1 are a first user 122 and a second user 132. One or both of the first and second users 122 and 132 may be a human user, a machine user (e.g., a computer configured by a software program to interact with the first device 120), or any suitable combination thereof (e.g., a human assisted by a machine or a machine supervised by a human). The first user 122 may be associated with the first device 120 and may be a user of the first device 120. For example, the first device 120 may be a desktop computer, a vehicle computer, a tablet computer, a navigational device, a portable media device, a smartphone, or a wearable device (e.g., a smart watch or smart glasses) belonging to the first user 122. Likewise, the second user 132 may be associated with the second device 130. As an example, the second device 130 may be a desktop computer, a vehicle computer, a tablet computer, a navigational device, a portable media device, a smartphone, or a wearable device (e.g., a smart watch or smart glasses) belonging to the second user 132. The first user 122 and a second user 132 may be examples of users or customers interfacing with the network-based system 105 to identify high value transactional events. The users 122 and 132 may interface with the network-based system 105 through the devices 120 and 130, respectively.

Any of the machines, databases 115, or first or second devices 120 or 130 shown in FIG. 1 may be implemented in a general-purpose computer modified (e.g., configured or programmed) by software (e.g., one or more software modules) to be a special-purpose computer to perform one or more of the functions described herein for that machine, database 115, or first or second device 120 or 130. For example, a computer system able to implement any one or more of the methodologies described herein is discussed below with respect to FIG. 6. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases 115, and devices (e.g., the server machine 110 and the first device 120). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

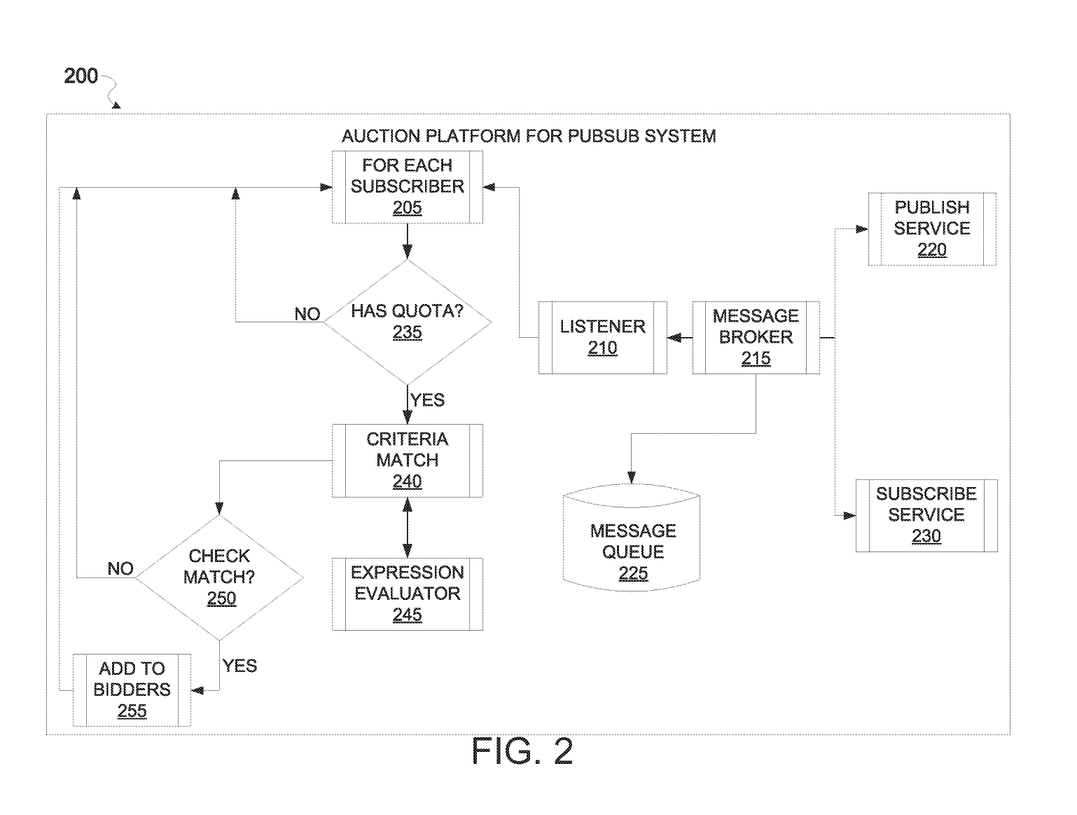

Referring to FIG. 2, illustration 200 shows an example functional block diagram of an auction engine or platform of the present disclosure, according to some embodiments. This block diagram includes functional elements for how the auction engine gathers auction criteria from a subscriber, how it communicates results of auctions, and how a subscriber's auction criteria are determined to fit into one or more planned auctions for various high value digital message content.

Starting a block 205, for each subscriber, a listener module 210 is configured to monitor any actions performed by the subscriber. As a general matter, a subscriber should have some verified amount of money in the auction system in order to participate in any auction. The listener 210 interacts with a message broker 215. When auction criteria are specified by the subscriber—which could occur at any time—the listener 210 picks up the communications and passes it onto the message broker 215, who begins the process of attempting to the connect the subscriber's information to the correct auction.

In some embodiments, the message broker 215 is configured to facilitate communication and interaction between the publishing service 220, the message queue 225, and the subscription service 230. The publishing service 220 enables a centralized publishing of records passing through the system. All subscribers—or in other cases only those subscribers who placed relevant bids—can see the centralized records, such as auction results, through the publishing service 220. The subscription service 230 can be configured to receive data. The subscription service 230 also provides quota or budget management capabilities. The message queue 225 provides an orderly way for data between the publishing service 220, the message broker 215, and the subscription service 230 to be managed. In some embodiments, the message queue 225 is a first-in first-out (FIFO) queue that store the messages and events as they arrive and is made available for processing.

The left side of the illustration 200 provides a functional block diagram for determining how to add a subscriber to an auction. Starting again from block 205, for any subscriber, the auction engine may first determine at block 235 whether the subscriber has an account with money and a quota that needs to be fulfilled through paying for advertising space related to digital message content. The auction engine of the present disclosure may be used similarly to other autonomous auction engines that facilitate the purchase of ad space in digital media. Typically, a subscriber has an available balance of money to spend on ad campaigns, and has instructions to utilize the spending of the account on a periodic basis, e.g., a daily, weekly, or monthly basis. The price for advertising space may be determined via auction, to best reflect free market valuation. Once the quota is met, the subscriber has finished its allotment of financial resources, and would not be allowed to participate in anymore auctions until the next period. This process may be performed automatically with little to no human interaction, as each subscriber may simply enter bidding criteria, and the auction engine would gather all information from all subscribers, evaluate each of the auction criteria, and resolve the auctions automatically at some predetermined time.

At block 240, the auction engine may access bidding criteria for some high value digital message content. The criteria may be evaluated by an expression evaluator 245, such as an engine utilizing NLP, ML, and/or UHRS programming. The expression evaluator 245 may access the subscription criteria entered by the subscriber and evaluate for its expression value. For example, the subscriber may specify to enter bids for “20% of all searches related women's outdoor apparel.” As another example, the subscriber may specify to enter bids for “500 searches across a 24 hour period for European travel,” while not knowing what percentage 500 searches constitutes for European travel over a 24 hour period (e.g., if there are 10,000 online searches for European travel, then 500 is 5%, but if there are only 2,000 searches over the same time period, then 500 is 25%). The search criteria can be even more complicated, including conditional or other logical expressions, such as “the greater of 50% of all car insurance searches, or 10,000 car insurance searches, over the period of 12 PM to 4 PM in all four continental US time zones.” Notice in each of these examples, the subscriber intends to bid on only a portion of all available content in each subject matter. The auction engine or platform of the present disclosure allows for subscribers to bid on the entire message content, or just a portion, even while not informing the subscriber what type and amount of content is available to be bid on.

At block 250, the auction engine determines whether the search criteria derived by the expression evaluator 245 matches, or in other words, fits within a category that is available for auction. If not, the process resets. However, if a match is found, then that subscriber is added as a bidder, according to their specified auction criteria, at block 255. A subscriber is considered to be a bidder in the auction if the criteria and matching conditions are successful. In some embodiments, every subscriber is considered a bidder for a transaction at a given point in time after all bids have been entered and evaluated (and at least a subset of those has been accepted).

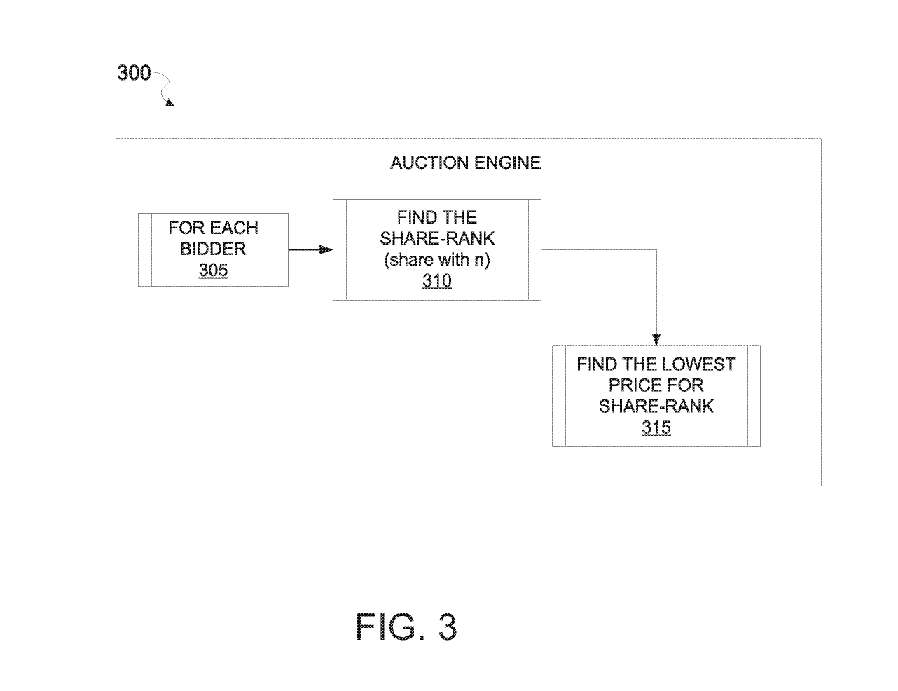

Referring to FIG. 3, illustration 300 shows a functional block diagram for how an auction is resolved, according to some embodiments. As previously mentioned, the auction engine of the present disclosure allows for bids to occupy just a portion of the available message content in an auction. A level of exclusivity of the bids is decided by how many other winners the bidder wants to share the content with. This is called share-rank for the bid. Starting at block 305, for each bidder, the auction engine determines, at block 310, which share-rank group each bidder wants to be in, which may be based on various calculations and according to the bidding criteria, as evaluated by the auction engine. For example, the bidder may have specified what portion it intends to bid for (e.g., “33%,” “¼,” “half,” “one fifth,” “500 out of the total,” etc.), and the auction engine would evaluate the share specified, placing the bidder in the appropriate share-rank. It is noted that there can be more bidders in a share-rank than there are shares in that share-rank. For example, there may be 15 bidders who want to place bids within share-rank 3. The auction engine first makes an evaluation of who wins the bids for the three shares in share-rank 3.

At block 315, for each share-rank, the lowest bid-price is taken as the value for that particular share-rank. Thus, the auction engine first determines the bidding value for each share-rank for the entire set of message content. In some embodiments, the accumulated price, which is the price to be compared against other share-ranks, is the lowest bid-price for a share-rank multiplied by the share-rank (e.g., for a share-rank of 4, the lowest bid-price in the share-rank of 4, multiplied by 4 to allow for an apples-to-apples comparison with other accumulated prices). The lowest price for a share-rank situation may be used so that the second price auction system that may be used in the auction platform cannot be rigged by collusion. As everybody still has an incentive to win the bid, and since there are two levels of bid comparison (i.e., one to determine what the bid level at each share rank is, and another to determine the overall winner(s)), one bid comparison that is based on the lowest bid while one that is based on the highest bid may properly incentivize bidders from cooperating with each other. Other mechanisms to determine the bid-price may result in an advantage for the high share-ranked bids, even though some of them may not have bid high. In some embodiments, other options like median, mean, or the average range of the 25 th to 75 th percentile, etc., can also be used to determine the bid-price.

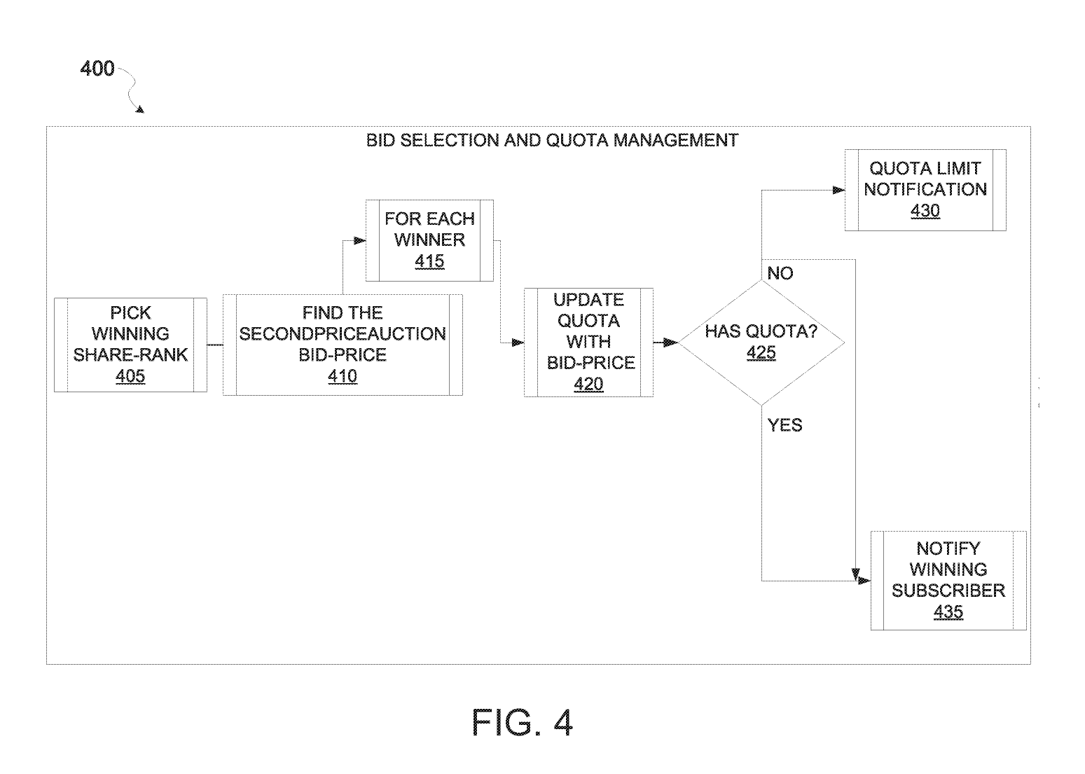

Referring to FIG. 4, illustration 400 provides a functional diagram for determining the winner of the auction and for conducting post-auction settlement actions, according to some embodiments. At block 405, after determining the values of each share-rank according to the descriptions of FIG. 3, the auction engine picks the winning share-rank. The members of each share-rank group are assessed for the auction. The one with highest accumulated price wins the auction. As previously mentioned, since determining the bid-price for each share rank may utilize a different ranking system than which share-rank wins the actual auction, collusion can be prevented or at least drastically reduced by requiring multiple variables for each subscriber to account for. In this way, the subscriber should be incentivized to simply make an honest bid, one that focuses on their own resources and perceived value of the digital content that is subject to auction.

In some embodiments, the auction engine facilitates a second-price auction, meaning that the price paid for by the winning bid is actually the second-highest bid. In these instances, at block 410, the auction engine finds the runner-up group's highest bid-price to determine the winning bid-price. If there is no other bid lower than the winning group, then it will be equal to the winning group price.

At block 415, for each member of the winning group, the auction engine performs a series of updates to change their accounts. Starting with block 420, the auction engine performs a “quota update” with the winning bid-price, by adjusting the amount spent for each winner according to their winning bid-price. The budget or quota is decremented by the lowest bid-price for the winning share-rank, according to some embodiments.

In some embodiments, the auction engine performs an additional check, and at block 425 determines if their quota has been reached. If so, the auction engine performs a “quota limits” notification at block 430. When bidders run out of the budget or quota that they have in their account, a notification is sent to the specific subscriber(s) so that they can allocate more. If there is still more to reach the quota, meaning that the quota or budget has not been reached, then the process skips block 430 and proceeds to block 435. A “winner notification” step is performed, where notification is sent to the winning subscriber(s) and the bid-price. This process may repeat on a periodic basis for any and all types of high value digital message content.

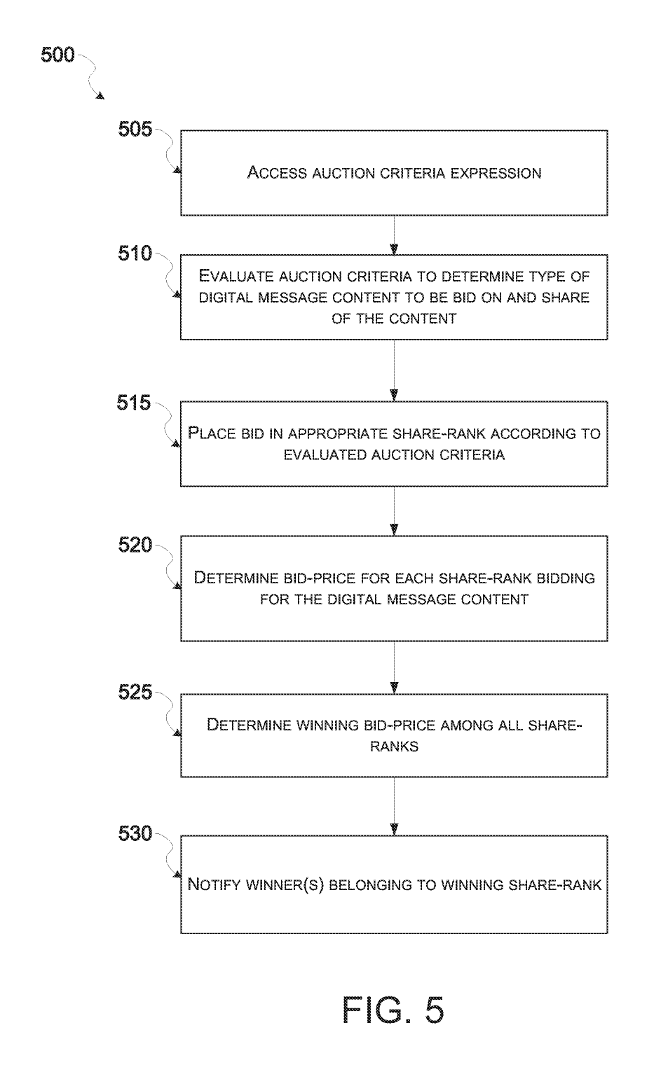

Referring to FIG. 5, flowchart 500 provides an example methodology of an auction engine of the present disclosure for harvesting bids to an auction and performing the auction, according to some embodiments. As described previously, the auctions of the present disclosure are unique in that the type of digital message content, and the amount that can be bid on, may be more open-ended and not predefined into discrete amounts specified by the auction engine. Rather, the type of content—and the amount—to be bid on is criteria-based, that is specified by the bidders themselves. This is unlike traditional auctions, where the auction engine or auction house defines the discrete objects, packages, or bundles, and their amounts that all bidders must operate within. Here, the bidder has much more control, and the auction engine is configured to evaluate the bids in order to fit all bids into appropriate auctions. The example methodology described herein may be consistent with the descriptions in FIGS. 1-4.

At block 505, the auction engine is configured to access auction criteria expression(s) from a bidder (subscriber). The auction engine may pick up the expression via a listener module or other interface. At block 510, the auction engine is configured to evaluate the auction criteria to determine the type of digital message content to be bid on, and what amount (share) of that content the bidder wants to try to win the rights to. The auction criteria may be in the form of a natural expression, written in ordinary vernacular, while still specifying a specific quantity and type of content. The auction engine may utilize natural language processing, machine learning, and/or UHRS modeling to evaluate each expression. The auction engine is flexible to allow varying amounts of the specified content to be bid on, and the auction for that content still performs a single auction for all bidders that may have different amounts (shares) specified.

At block 515, the auction engine may add the bid to the auction, and place the bid in the appropriate share-rank according to the evaluated auction criteria in block 510. The auction may repeat the processes in block 505, 510 and 515 for every subscriber who places bids indicating an intent to participate in the auction for a particular set of high value digital message content.

Once all of the bids have been evaluated and placed in their respective share-ranks for auction of the particular digital message content, the auction may resolve the auction and determine one or more winners. At block 520, the auction engine proceeds by determining a bid-price for each share-rank bidding for the digital message content. An example for determining the bid-price for each share-rank is described above, such as in FIG. 3. At this point, all share-ranks that have bids placed into them by various subscribers will have a determined bid-price associated to them. At block 525, the auction engine then compares all of the bid-prices of each of the share-ranks and determines the winning bid-price. For example, the highest accumulated bid-price of all of the share-ranks represents the winning bid, although the winning share-rank (and the subscribers within that share-rank who are associated with how that bid-price was determined) may pay the second highest bid-price, if the auction is a second price auction, for example.

At block 530, the auction engine may resolve the accounts of the winning bidders by updating their quota accounts, and ultimately will notify the winner(s) of the results. In addition, the overall results may be posted for all subscribers to see what the winning bids were, at what share-rank.

Referring to FIG. 6, the block diagram illustrates components of a machine 600, according to some example embodiments, able to read instructions 624 from a machine-readable medium 622 (e.g., a non-transitory machine-readable medium, a machine-readable storage medium, a computer-readable storage medium, or any suitable combination thereof) and perform any one or more of the methodologies discussed herein, in whole or in part. Specifically, FIG. 6 shows the machine 600 in the example form of a computer system (e.g., a computer) within which the instructions 624 (e.g., software, a program, an application, an applet, an app, or other executable code) for causing the machine 600 to perform any one or more of the methodologies discussed herein may be executed, in whole or in part.

In alternative embodiments, the machine 600 operates as a standalone device or may be connected (e.g., networked) to other machines. In a networked deployment, the machine 600 may operate in the capacity of a server machine 110 or a client machine in a server-client network environment, or as a peer machine in a distributed (e.g., peer-to-peer) network environment. The machine 600 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 624, sequentially or otherwise, that specify actions to be taken by that machine. Further, while only a single machine 600 is illustrated, the term “machine” shall also be taken to include any collection of machines that individually or jointly execute the instructions 624 to perform all or part of any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a video display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eye tracking device, or other pointing instrument), a storage unit 616, a signal generation device 618 (e.g., a sound card, an amplifier, a speaker, a headphone jack, or any suitable combination thereof), and a network interface device 620.

The storage unit 616 includes the machine-readable medium 622 (e.g., a tangible and non-transitory machine-readable storage medium) on which are stored the instructions 624 embodying any one or more of the methodologies or functions described herein, including, for example, any of the descriptions of FIGS. 1-5. The instructions 624 may also reside, completely or at least partially, within the main memory 604, within the processor 602 (e.g., within the processor's cache memory), or both, before or during execution thereof by the machine 600. The instructions 624 may also reside in the static memory 606.

Accordingly, the main memory 604 and the processor 602 may be considered machine-readable media 622 (e.g., tangible and non-transitory machine-readable media). The instructions 624 may be transmitted or received over a network 626 via the network interface device 620. For example, the network interface device 620 may communicate the instructions 624 using any one or more transfer protocols (e.g., HTTP). The machine 600 may also represent example means for performing any of the functions described herein, including the processes described in FIGS. 1-5.

In some example embodiments, the machine 600 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 622 able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database 115, or associated caches and servers) able to store instructions 624. The term “machine-readable medium” shall also be taken to include any medium, or combination of multiple media, that is capable of storing the instructions 624 for execution by the machine 600, such that the instructions 624, when executed by one or more processors of the machine 600 (e.g., processor 602), cause the machine 600 to perform any one or more of the methodologies described herein, in whole or in part. Accordingly, a “machine-readable medium” refers to a single storage apparatus or device 120 or 130, as well as cloud-based storage systems or storage networks that include multiple storage apparatus or devices 120 or 130. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 622 is non-transitory in that it does not embody a propagating signal. However, labeling the tangible machine-readable medium 622 as “non-transitory” should not be construed to mean that the medium is incapable of movement; the medium should be considered as being transportable from one physical location to another. Additionally, since the machine-readable medium 622 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 622 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 602 or a group of processors 602) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 602 or other programmable processor 602. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 608) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 602 that are temporarily configured (e.g., by software) or permanently configured to perform the relevant operations. Whether temporarily or permanently configured, such processors 602 may constitute processor-implemented modules that operate to perform one or more operations or functions described herein. As used herein, “processor-implemented module” refers to a hardware module implemented using one or more processors 602.

Similarly, the methods described herein may be at least partially processor-implemented, a processor 602 being an example of hardware. For example, at least some of the operations of a method may be performed by one or more processors 602 or processor-implemented modules. As used herein, “processor-implemented module” refers to a hardware module in which the hardware includes one or more processors 602. Moreover, the one or more processors 602 may also operate to support performance of the relevant operations in a “cloud computing” environment or as a “software as a service” (SaaS). For example, at least some of the operations may be performed by a group of computers (as examples of machines 600 including processors 602), with these operations being accessible via a network 626 (e.g., the Internet) and via one or more appropriate interfaces (e.g., an API).

The performance of certain operations may be distributed among the one or more processors 602, not only residing within a single machine 600, but deployed across a number of machines 600. In some example embodiments, the one or more processors 602 or processor-implemented modules may be located in a single geographic location (e.g., within a home environment, an office environment, or a server farm). In other example embodiments, the one or more processors 602 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 600 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method of an auction platform for conducting an auction for a set of digital message content, the set of digital message content capable of being subdivided into multiple portions of digital message content, the method comprising:
accessing, by the auction platform, an auction criteria expression from a subscriber of the auction engine, the auction criteria expression comprising:
a description of auction content to bid on that is associated with the set of digital message content;
a bidding amount representing a portion of the set of digital message content that the subscriber intends to bid on, wherein the portion is a subset of the entire set of digital message content; and
a bid-price representing a price that the subscriber is willing to pay for the bidding amount portion of the digital message content;
evaluating, by a natural language processing engine of the auction platform, the auction criteria expression to determine a bid associated with the digital message content, the bid comprising:
the description of the digital message content;
the portion of the set of digital message content that the subscriber wants to bid on; and
the bid-price of that portion;
placing the bid into the auction for the set of digital message content by placing the bid into a share-rank, the share-rank comprising all bids from a plurality of subscribers bidding for only the portion of the set of digital message content;
determining, by the auction platform, that the subscriber's bid is associated with a winning share-rank for the set of the digital message content; and
notifying, by the auction platform, the subscriber that the subscriber's bid is a winning bid and is associated with the winning share-rank for the set of the digital message content.

2. The method of claim 1, wherein determining that the subscriber's bid is associated with a winning share-rank for the set of the digital message content comprises determining an accumulated bid-price for the share-rank that the subscriber's bid is placed into;
comparing the accumulated bid-price of the subscriber's bid's share-rank to other accumulated bid-prices of other share-ranks; and
determining that the accumulated bid-price of the subscriber's bid's share-rank is the highest accumulated bid-price.

3. The method of claim 1, further comprising:
determining a plurality of additional winning subscribers' bids belonging to the winning share-rank; and
notifying, by the auction platform, the plurality of additional winning subscribers that their respective winning bids are associated with the winning share-rank for the set of the digital message content.

4. The method of claim 1, wherein evaluating the auction criteria expression to determine a bid associated with the digital message content comprises utilizing natural language processing, machine learning, and Universal Human Relevance System programming to evaluate the auction criteria expression.

5. The method of claim 1, wherein the auction for the set of digital message content comprises a plurality of share-ranks, the plurality of share ranks including:
a first share-rank representing all bids that each want to bid on the entire set of the digital message content;
a second share-rank representing all bids that each want to bid on half of the set of the digital message content;
a third share-rank representing all bids that each want to bid on a third of the set of the digital message content; and
a fourth share-rank representing all bids that each want to bid on a fourth of the set of the digital message content.

6. The method of claim 1, further comprising determining, by the auction platform, that the subscriber has a quota of funds to spend that has not yet been expended through winning one or more auctions.

7. The method of claim 1, further comprising determining, by the auction platform, that the subscriber has reached a quota limit by being associated with the winning share-rank for the digital message content.

8. An auction system for conducting an auction for a set of digital message content, the set of digital message content capable of being subdivided into multiple portions of digital message content, the auction system comprising:
an auction engine;
a portal for interfacing with one or more subscribers; and
a natural language processing engine;
wherein:
the auction engine is configured to:
access, via the portal, an auction criteria expression from a subscriber, the auction criteria expression comprising:
a description of auction content to bid on that is associated with the set of digital message content;
a bidding amount representing a portion of the set of digital message content that the subscriber intends to bid on, wherein the portion is a subset of the entire set of digital message content; and
a bid-price representing a price that the subscriber is willing to pay for the bidding amount portion of the digital message content;
the natural language processor is configured to evaluate the auction criteria expression to determine a bid associated with the digital message content, the bid comprising:
the description of the digital message content;
the portion of the set of digital message content that the subscriber wants to bid on; and
the bid-price of that portion;
and the auction engine is further configured to:
place the bid into the auction for the set of digital message content by placing the bid into a share-rank, the share-rank comprising all bids from a plurality of subscribers bidding for only the portion of the set of digital message content;
determine that the subscriber's bid is associated with a winning share-rank for the set of the digital message content; and
notify the subscriber that the subscriber's bid is a winning bid and is associated with the winning share-rank for the set of the digital message content.

9. The system of claim 8, wherein determining that the subscriber's bid is associated with a winning share-rank for the set of the digital message content
comprises determining an accumulated bid-price for the share-rank that the subscriber's bid is placed into;
comparing the accumulated bid-price of the subscriber's bid's share-rank to other accumulated bid-prices of other share-ranks; and
determining that the accumulated bid-price of the subscriber's bid's share-rank is the highest accumulated bid-price.

10. The system of claim 8, wherein the auction engine is further configured to:
determine a plurality of additional winning subscribers' bids belonging to the winning share-rank; and
notify the plurality of additional winning subscribers that their respective winning bids are associated with the winning share-rank for the set of the digital message content.

11. The system of claim 8, wherein evaluating the auction criteria expression to determine a bid associated with the digital message content comprises utilizing natural language processing, machine learning, and Universal Human Relevance System programming to evaluate the auction criteria expression.

12. The system of claim 8, wherein the auction for the set of digital message content comprises a plurality of share-ranks, the plurality of share ranks including:
a first share-rank representing all bids that each want to bid on the entire set of the digital message content;
a second share-rank representing all bids that each want to bid on half of the set of the digital message content;
a third share-rank representing all bids that each want to bid on a third of the set of the digital message content; and
a fourth share-rank representing all bids that each want to bid on a fourth of the set of the digital message content.

13. The system of claim 8, wherein the auction engine is further configured to determine that the subscriber has a quota of funds to spend that has not yet been expended through winning one or more auctions.

14. The system of claim 8, wherein the auction engine is further configured to determine that the subscriber has reached a quota limit by being associated with the winning share-rank for the digital message content.
